(19) United States
(12) Patent Application Publication
(10) Pub. No.: US 2016/0360603 A1
(43) Pub. Date: Dec. 8, 2016

(54) MULTI-COMPONENT ELECTRODE FOR A PLASMA CUTTING TORCH AND TORCH INCLUDING THE SAME

(71) Applicant: LINCOLN GLOBAL, INC., City of Industry, CA (US)

(72) Inventor: Yun Yang, Mt. Pleasant, SC (US)

(21) Appl. No.: 14/729,900

(22) Filed: Jun. 3, 2015

(51) Int. Cl. H05H 1/34

(52) U.S. Cl. CPC H05H 1/34; H05H 2001/3436; H05H 2001/3442

(57) ABSTRACT

Embodiments of the present invention are directed to a plasma arc cutting torch and an electrode assembly used in the torch. The electrode assembly includes a high thermionic emissive insert and a high thermally conductive wrap which covers at least a portion of the insert. The wrap aids in cooling the insert during operation and improves the operational life of the electrode.

### TECHNICAL FIELD

Devices, systems, and methods consistent with the invention relate to cutting, and more specifically to devices, systems and methods related to plasma arc cutting torches and components thereof, including a multi-component electrode for use in an arc plasma cutting torch.

### BACKGROUND

In many cutting, spraying and welding operations, plasma arc torches are utilized. With these torches a plasma gas jet is emitted into the ambient atmosphere at a high temperature. The jets are emitted from a nozzle and as they leave the nozzle the jets are highly under-expanded and very focused. However, because of the high temperatures associated with the ionized plasma jet many of the components of the torch are susceptible to failure. This failure can significantly interfere with the operation of the torch and prevent proper arc ignition at the start of a cutting operation. Some torches utilize copper electrodes having an insert, in addition to a hafnium insert, in an effort to address these problems. An example of this is disclosed in U.S. Pat. No. 5,097,111, the entire disclosure of which is incorporated herein by reference. This patent explains the use of an additional insert within the electrode. However, this solution still does not alleviate the failure issues discussed above.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY OF THE INVENTION

An exemplary embodiment of the present invention is an electrode assembly and a plasma torch containing the same, where the electrode assembly contains an emissive insert (e.g., hafnium) and a thermally conductive wrap surrounding the insert. The wrap is made from a high thermally conductive material or a composite of materials to aid in the cooling of the insert and prevent the jumping of an arc from the insert to the electrode body.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary multi-component electrode of the present invention;

FIG. 2 is a diagrammatical representation of a portion of the electrode of FIG. 1;

FIG. 3 is a diagrammatical representation of a portion of another exemplary electrode of the present invention;

FIG. 4 is a diagrammatical representation of an exemplary plasma arc cutting torch utilizing the electrode of FIG. 3;

FIG. 5 is a diagrammatical representation of a portion of an additional embodiment of the present invention;

FIG. 6 is a diagrammatical representation of a portion of a further embodiment of the present invention, and

FIG. 7 is a diagrammatical representation of a portion of an additional exemplary embodiment of the present invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

The present disclosure is generally directed to both air and liquid cooled plasma arc torches useful various cutting, welding and spraying operations. The construction and operation of these torches are generally known, and thus their detailed construction and operation will not be discussed herein. Further, embodiments of the present invention can be used in either handheld or mechanized plasma cutting operations. It should be noted that for purposes of brevity of clarity, the following discussion will be directed to exemplary embodiments of the present invention which are liquid cooled and can be used for both mechanized and hand geld cutting operations. However, embodiments of the present invention are not limited in this regard and embodiments of the present invention can be used in other types of welding and spraying torches without departing from the spirit or scope of the present invention. Further, various types and sizes of torches are possible at varying power levels if desired. The torches and components described herein could be used for marking, cutting or metal removal. Additionally, exemplary embodiments of the present invention, can be used with varying currents and varying power levels. The construction and utilization of coolant systems of the type that can be used with embodiments of the present invention are known and need not be discussed in detail herein.

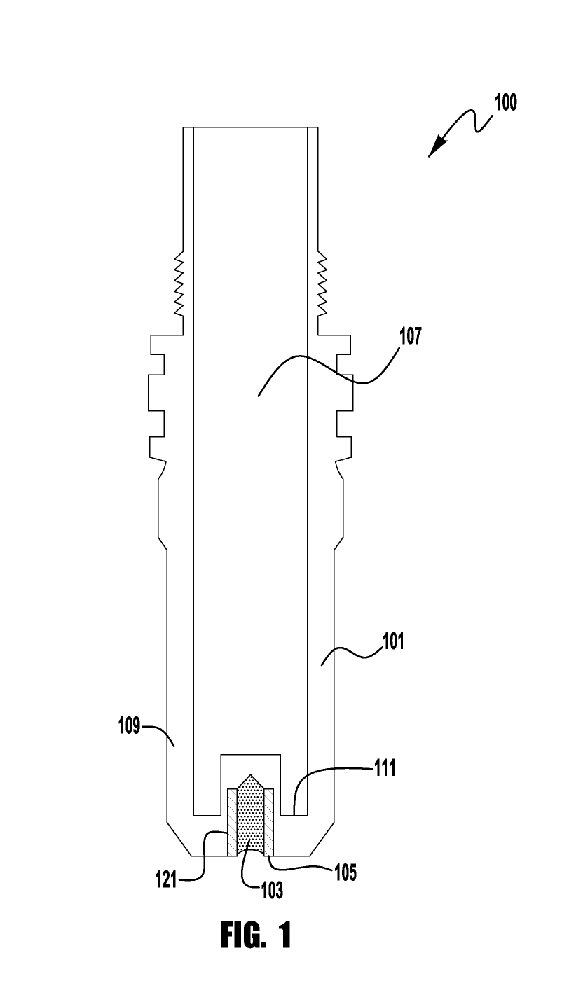

Turning now to FIG. 1, an exemplary electrode 100 of the present invention is depicted. The use and construction of plasma cutting electrodes is generally well known and those details need not be discussed herein. As shown the electrode 100 has an electrode body 101 which is typically made up of copper, or other highly thermally conductive material, such as silver, gold, nickel, etc. The electrode 100 comprises a cooling cavity 107 in which a cooling medium can be directed to aid in cooling the electrode 100. At the distal end of the electrode 100, within the cavity 107 a protrusion portion 109 extends into the cavity 107, where the protrusion portion 109 extends out of the distal end surface 111 of the cavity 107. As discussed further below, the protrusion portion 109 contains a portion of the insert 103 and increases the surface cooling area within the cavity 107 of the electrode 100.

As mentioned above, the electrode 100 includes a high thermionic emissive insert 103. During cutting, the plasma jet emits from this insert. Often this insert 103 is made from hafnium, but other materials such as zirconium and tungsten (and other similar materials) can be used. Typically, the usable life of the electrode 100 depends on the usable life of the insert 103, which tends to erode during operation. Further, the erosion of the insert 103 can be accelerated if the cooling of the insert 103 and the electrode body 101 is not optimal. Also, the generated plasma jet can have a tendency to jump from the insert 103 and make contact with the distal end of the electrode body 101. This can cause damage to the electrode body 101 and accelerate its failure.

Therefore, embodiments of the present invention utilize an insert wrap 105 which is wrapped around an exterior of the insert 103 and is inserted into the distal end of the electrode body 101 as shown. In exemplary embodiments of the present invention, the wrap 105 is made from a high heat transfer material, and can be a composite material. By having a high heat transfer rate the wrap 105 aids in optimizing the cooling of the insert 103. Thus, embodiments of the present invention have improved operating life over known electrodes.

The wrap 105 can be made from a number of high heat transfer rate materials, and composites thereof. For example, in some exemplary embodiments the wrap can be made of a material having a very high thermally conductivity, or can have a matrix material of either copper or silver which is impregnated with another material of high thermal conductivity. Each of copper and silver have a relatively good thermal conductivity. Copper has a thermal conductivity of about 401 W/mK at 20° C., and silver has a conductivity of about 429 W/mK at 20° C. While these are acceptable for some applications, it is desirable to have considerably higher conductivity to aid in removing heat from the insert 103. Therefore, in exemplary embodiments, the wrap 105 is made from a material having a thermally conductivity of at least 700 W/mK at 20° C. In further exemplary embodiments, the wrap 105 is made from a material having a thermal conductivity of at least 1,000 W/mK at 20° C. In further exemplary embodiments, the material has a thermal conductivity in the range of 1,000 to 2,500 W/mK at 20° C. It is noted that, because exemplary embodiments of the present invention can use a composition or matrix of materials (as discussed in more detail below) the above thermal conductivity discussion is directed to the overall thermal conductivity of the wrap 105. That is, the wrap 105 can be made up of a matrix of materials having thermal conductivity characteristics above or below the numbers but the overall conductivity is as described above. Additionally, because heat can affect the thermal conductivity of materials (e.g., the thermal conductivity can increase at higher temperatures), materials contemplated by embodiments of the present invention also have a higher thermal conductivity than silver even at higher temperatures. That is, the thermally conductive material contemplated by embodiments of the present invention, will have a higher thermal conductivity than silver throughout the operational temperature range experienced during cutting operations, which can range from 100 to 1600° C. For example, some exemplary embodiments can use a wrap 105 which is made from carbon chain materials, such as diamonds, nano-tube or nano-fibers and graphene. These types of carbon chain materials can have a very high thermal conductivity—higher than 2,000 W/mK—and can be placed on the hafnium insert 103 via a deposition process, such as vapor deposition. For example, a DLC (diamond like carbon) coating can be placed on the insert 103 via vapor deposition before the insert 103 is coupled to the electrode body 101. This layer/wrap 105 greatly aids in the cooling of the insert 103 as its thermal conductivity is much higher than copper or silver. Further, some of these materials, such as graphene, also have a relatively high electrical conductivity, which aids in allowing the cutting current to pass from the electrode body 101 to the insert 103. In exemplary embodiments, the wrap 105 of the carbon chain material can have a thickness in the range of 10 to 50 microns. In other exemplary embodiments, the thickness of the wrap 105 can be thicker. Thus, in exemplary embodiments of the present invention, the wrap 105 is made from high thermal conductivity materials. In further exemplary embodiments, the wrap 105 material can also have low thermal expansion—to maintain dimensional integrity, and can be electrically conductive. His will aid in optimizing the performance of the electrodes contemplated herein.

In exemplary embodiments of the present invention, the wrap can be press-fit with the insert 103 and the electrode body 101, where a crimping force is applied to the electrode body 101 so as to squeeze the insert 103 and the wrap 105 to secure the components in the body 101. However, exemplary embodiments are not limited to this and other methods of securing the components can be used. For example, the wrap 105 can have a metallurgical connection with the insert and/or the body 101. Examples of such connections can be via soldering.

In additional exemplary embodiments, the wrap 105 can be made of a composite material, having a base matrix material—which can be copper or silver, for example—and a high thermal conductivity material suspended in the matrix. Again, the suspended material can be a carbon based material, such as diamonds, etc. In other exemplary embodiments, the suspended material can be thermal pyrolytic graphite (TPG). TPG is a form of pyrolytic graphite manufactured from thermal decomposition of hydrocarbon gas in a high temperature chemical vapor deposition reactor. Materials such as TPG can have a thermal conductivity of at least 1,500 W/mK at 20° C. Further, these materials can be suspended in a silver or copper matrix via processes, such as sintering, and create a composite material wrap 105 that greatly improves the thermal performance of the insert 103. The composite wrap 105, again, is placed on an outer surface of the insert 103, and is positioned between the insert 103 and the electrode body 101. Because a matrix material of copper or silver is used—each having a relatively high electrical conductivity—the wrap 105 can fully cover the insert 103 within the body 101. In FIG. 1, the wrap 105 does not full engulf the insert 103 (within the body 101). However, in embodiments where the wrap has good electrical conductivity, the wrap 105 can cover the insert 103 such that no portion of the insert 103 directly contacts the material of the body 101.

In further exemplary embodiments, the material of the wrap 105 can be made from metallurgical alloys which provide the desired thermal and electrical performance. For example, an alloy comprising copper, chromium, zinc and titanium can be used. In further exemplary embodiments a powder sintering process can be used to create a metal matrix composite of materials which provide the desired thermal and electrical properties. An example of such a composite would be a metal-diamond composite material can be used to achieve the desired thermal and electrical properties. The metal can be any of the materials, alloys referenced herein, as well as others that have the desired properties. Additionally, a nano-fiber enforced composite process can be used to create a wrap 105 of the present invention. For example a carbon or graphene enforced composite can be used.

In further exemplary embodiments of the present invention, the electrode body 101 itself is a composite material. For example, the electrode body can be made of a copper or silver matrix material having a carbon based material impregnated within it—such as diamonds—which improves the overall thermal conductivity of the electrode body. Again, the carbon material can be impregnated with a process such as sintering. Of course, other manufacturing processes can be used to create a composite material electrode body 101. Further, in other exemplary embodiments, only the cavity 121 in which the insert 103 is inserted can be impregnated with carbon materials, such as diamonds. That is, in some embodiments, the majority of the electrode body 101 is a solid material, such as copper or silver, but the walls of the cavity 121 on the distal end of the electrode 100 are impregnated with diamonds, or some of the other materials discussed above, such that the thermal conductivity electrode body 101 in the area of the of the cavity 121 is increased over the remainder of the electrode body 101. In exemplary embodiments of the present invention, the thermal conductivity of the impregnated portions of the electrode body 101 have a thermal conductivity in the range of 500 to 1,000 W/mK at 20° C. In some of such embodiments, the wrap 105 is not needed and thus not used, such that the insert 103 makes direct contact with the composite walls of the cavity 121. In further exemplary embodiments, each of a wrap 105 and a composite material cavity 121 is used.

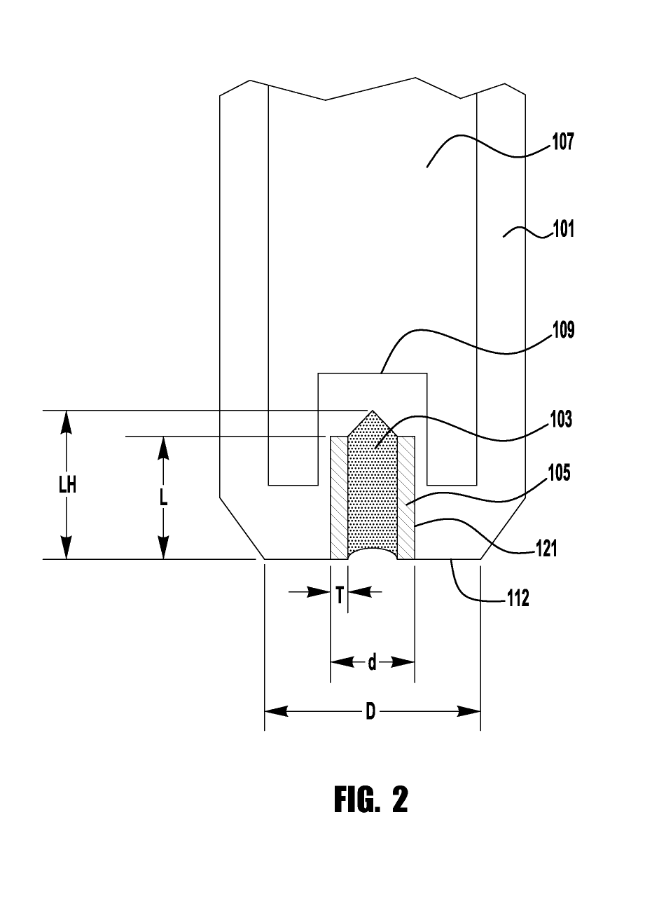

FIG. 2 depicts a closer view of the distal end of the electrode 100 described above. As shown, the wrap 105 is secured into the cavity 121 formed at the distal end of the electrode 100 such that the distal end surfaces of the shell 105 wrap and the body 101 are generally coplanar. As explained above, when the material of the wrap 105 has a good electrical conductivity it can completely enclose the insert 103 and separate the insert 103 from the material of the body 101. It is understood, that this does not mean that the distal end face of the insert is “enclosed”. However, in other embodiments, the material of the wrap 105 may not have ideal electrical conductivity. In such embodiments, the wrap 105 does extends a length L along the insert 103 such that at least a portion of the insert 103 makes direct contact with the cavity 121 of the electrode body 101. In the embodiment shown in FIG. 2, the wrap 105 has a length L and the insert has a total length, as measured from the distal face 112 of the body, of LH. In exemplary embodiments, the length L of the wrap 105 is in the range of 90 to 40% of the length LH. In other exemplary embodiments, the length L is in the range of 80 to 55% of the length LH. Typically, the length L is chosen such that sufficient electrical contact is made between the insert 103 and the body 101 so that the cutting current can be passed to the insert 103 to generate the plasma.

Further, in the embodiment shown, the wrap 105 has a constant thickness T, so that the cavity 121 is generally cylindrical. However, as further discussed below, in some embodiments, the thickness T can vary. Further, depending on the materials used for the wrap, the thickness T of the wrap 105 can range from 10 to 50 microns. However, in other exemplary embodiments, the thickness T can be much larger and can be in the range of 0.04 to 0.2 inches. Of course, other thickness can be used as well, and will be a function of the size constraints of the electrode body 101 and the desired thermal conductivity performance.

Additionally, as shown, the wrap 105 has an outside diameter d—as measured on the distal face 112 of the body 101—where the diameter d is in the range of 35 to 95% of the diameter D of the distal end face 112 of the body 101. In other embodiments, the diameter d is in the range of 45 to 85% of the diameter D. It is noted that the diameter D is the diameter of the flat end face surface 112 of the distal end of the body 101.

It should be noted that embodiments of the present invention can be used with cutting torches and systems that vary widely in the current and power levels. That is, embodiments of the present invention can be used in cutting system from below 100 amps to higher than 400 amps. However, because of the thermal attributes of exemplary embodiments of the present invention, many of the benefits of embodiments disclosed herein will be more appreciated in cutting applications which have higher current levels. For example, electrodes discussed herein can be used in cutting applications in the range of 275 to 400 amps. Further, because of the different demands put on consumables when operating at different current levels, the dimensional relationships of some of the components discussed herein can be optimized for different current levels.

When assembling/manufacturing exemplary embodiments of the electrode 100, as shown, the insert 103 and the wrap 105 (if present) is inserted into the cavity 121. Then a radially directed compressive force is applied on the sides the electrode body 101 at the distal end such that the wrap 105 and insert 103 are crimped into the electrode body 101 and held in place by this crimp force. The radial crimping force is applied such that the outside diameter of the electrode body 101 at the crimp force location is reduced by about 3 to 8%.

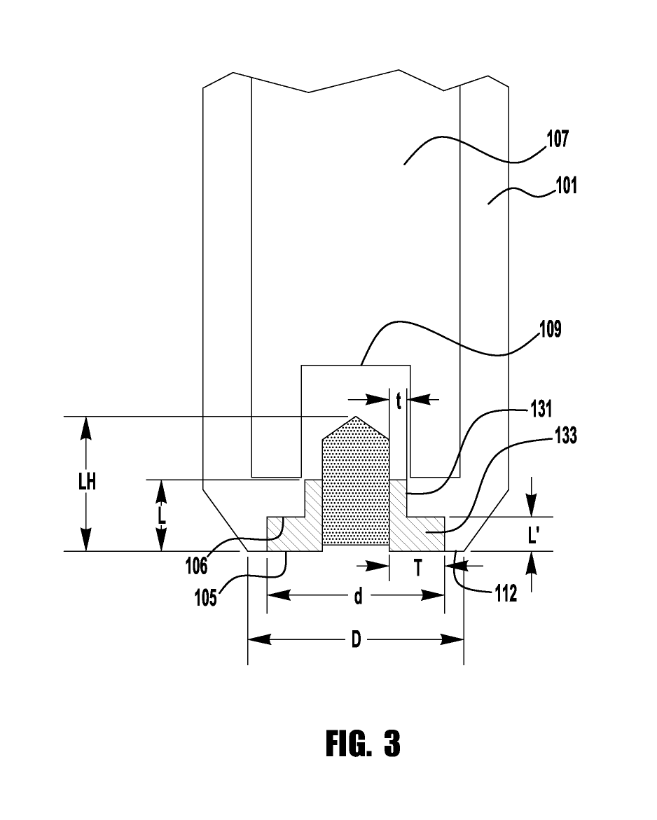

FIG. 3 depicts another exemplary embodiment of the wrap 105 of the present invention. As shown, in this embodiment the wrap 105 has a variable wall thickness along its length L. In the embodiment shown, the wrap 105 has a thick distal end portion 133 and a thin walled upstream portion 131. Such an embodiment can be used to increase the mass of the wrap 105 without compromising the structural integrity of the protrusion portion 109 of the electrode 100. The thicker portion 133 has a wall thickness T which is thicker than the wall thickness t of the upstream portion 131. In exemplary embodiments, the thickness T is in the range of 400 to 50% thicker than that of the thickness t. In other embodiments, the thickness T is in the range of 300 to 100% thicker than the thickness t. Further, the thick distal portion 133 has a length L′, where the length L′ is in the range of 35 to 75% of the length of the overall length L of the wrap 105. In further exemplary embodiments, the length L′ is in the range of 45 to 65%. In the embodiment shown, the wrap 105 has a single thickness step/transition from the distal portion 133 to the upstream portion 131. However, other exemplary embodiments can use multiple thickness changes. Embodiments of the present invention are not limited to the configuration shown in FIG. 3.

Additionally, while FIG. 3 depicts the wrap 105 having a diameter d which is less than the diameter D, in other exemplary embodiments the wrap can fully cover the distal end of the body 101, such that the wrap 105 encompasses the entirety of the end diameter D of the distal face 112. In such embodiments, the wrap 105 can be an end cap of the body 101, where the entirety of the diameter D of the distal face 112 and at least some of the side wall portion of the body 101 can be made of the wrap 105 component. Thus, in such embodiments the wrap 105 can function as an end cap or a plug at the distal end of the body 101 and the cavity 107.

Further, in exemplary embodiments of the present invention the electrode body 101 is made from an oxygen-free high thermal conductivity copper. Such copper alloys typically are 99.99% pure copper with a low oxygen content of no more than 0.0005% by weight. An example of such a copper alloy is C10100. A copper of this alloy provides the heat transfer characteristics that are desirable but is also susceptible to machining and crimping—so as to be crimped with the grooves in the shell.

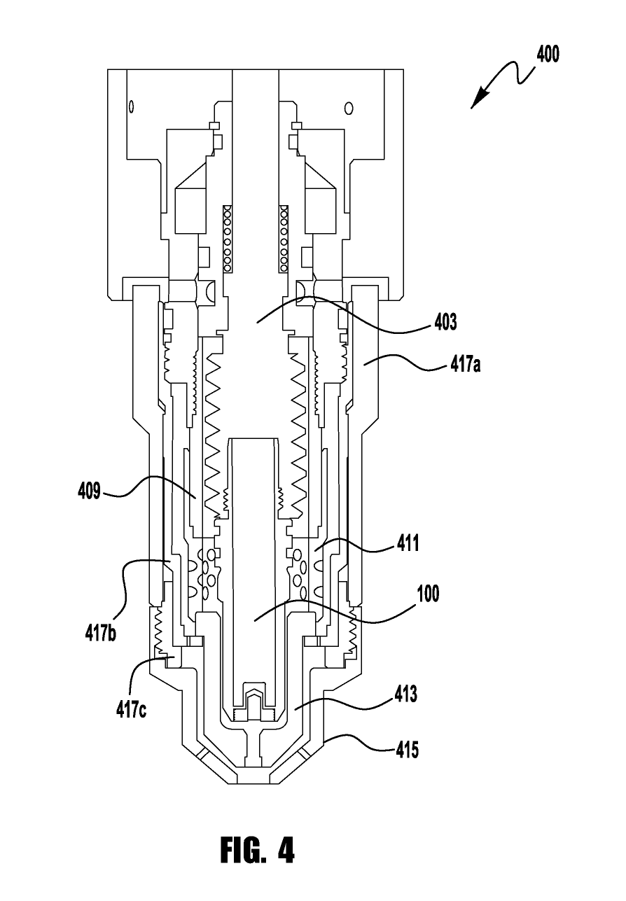

Turning now to FIG. 4, a torch assembly 400 is shown which utilizes an exemplary electrode 100 of the present invention. As mentioned previously, the torch 400 can be any type of known plasma arc cutting torch including, but not limited to air cooled, liquid cooled, contact start, non-contact start, high current, low current, handheld and/or mechanized. Embodiments of the present invention are not limited in this regard. Further, because the general construction and operation of such torches is known, those details need not be discussed herein. As shown in FIG. 4, an exemplary torch 400 can include the electrode assembly 100 discussed herein, and components such as a shield cap 415, nozzle 413, swirl ring 411, a cathode body 403, to which the electrode 100 is secured—often by threads at the electrode assembly 100. The torch can also include components such as an isolator structure 409 and a retaining cap assembly 417a-417c which aids in securing the shield 415 and nozzle 413 to the torch 400. As is generally understood, the insert 103 emits the plasma jet/arc which exits through an opening in the nozzle 413 and then out through an opening in the shield cap 415. Further, a shield gas can be provided to the torch, which is then passed between the nozzle 413 and shield cap 415 to also be ejected through an opening at the distal end of the shield cap 415.

The operation of the torch assembly 400, using the exemplary electrode assembly 100 is no different than the operation of known torches. However, because of the attributes discussed above, the electrode assembly 100 will have a longer life than known electrodes. Therefore, embodiments of the present invention provide significant improvements over known electrodes.

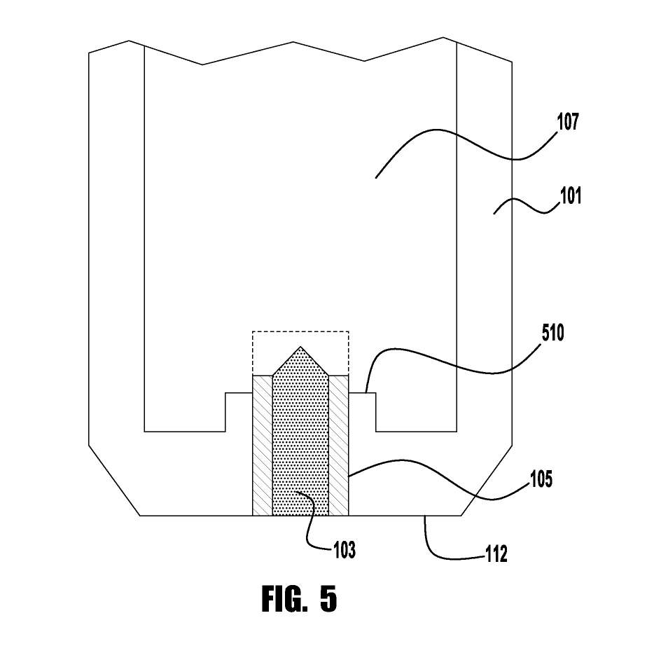

FIGS. 5 through 7 depict further exemplary embodiments of the present invention that can be used in the cutting processes and exemplary torch assembly 400 discussed herein.

FIG. 5 depicts an exemplary embodiment similar to that discussed in FIG. 2. However, in this exemplary embodiment each of the wrap 105 and the insert 103 are exposed to the cooling cavity 107. In such embodiments, the wrap and the insert can be directly cooled by the coolant in the electrode—which can be either liquid or air/gas. In further exemplary embodiments, the wrap 105 can fully cover (as shown by the dashed lines in FIG. 5) the insert in the cavity 107 such that only the wrap 105 is in contact with the coolant in the cavity 107.

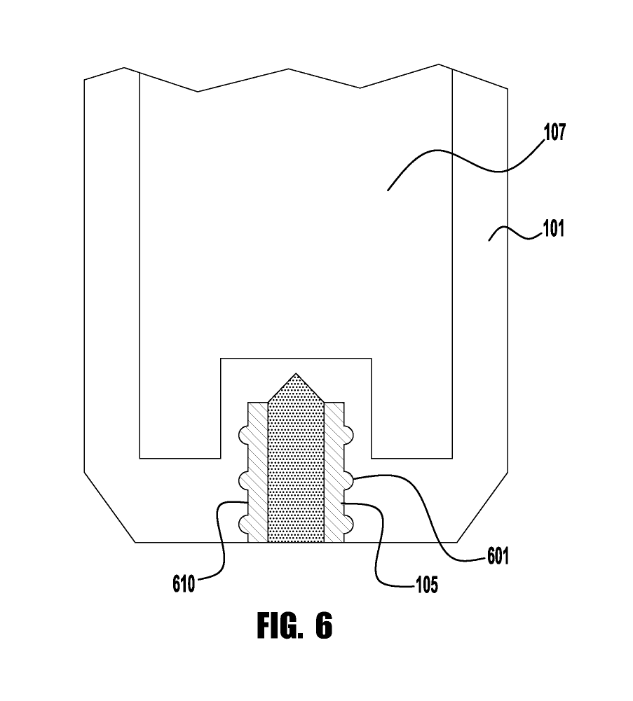

FIG. 6 depicts a further exemplary embodiment which is, again, similar to that shown in FIG. 2. However, in this exemplary embodiment, the wrap 105 has a plurality of protrusions 601 which extend out from an outer surface 610 of the wrap 105. The protrusions 601 aid in securing the wrap within the body 101. For example, when the body is crimped onto the wrap 105, the crimp force can deform the body 101 around the protrusions 601 and the wrap 105 which will aid in securing the wrap 105 within the body 101. Moreover, the protrusions 601 increase the contact surface area, which will increase the thermal conductivity of the connection. The protrusions 601 can have any desired shape or configuration.

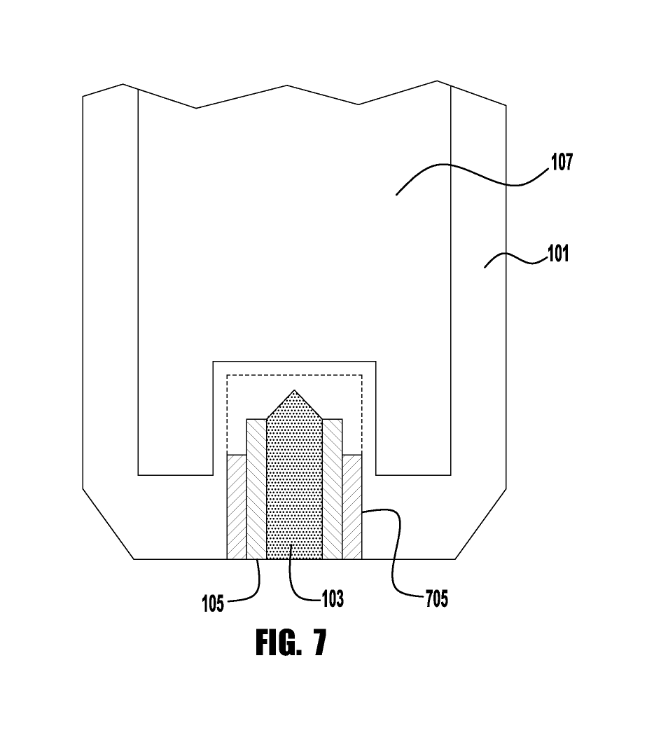

FIG. 7 depicts an additional exemplary embodiment where a second wrap 705 is used. As shown, the insert 103 is in contact with a first wrap 105, and the first wrap 105 is in contact with a second wrap 705. The second wrap can be made of different high thermally conductive materials than the first wrap 105, and have a different thermal conductivity. For example, the outer wrap 705 can have a lower thermal conductivity than the inner wrap 105. Further, as shown, the outer wrap 705 can have a length which less than the inner wrap 705. Of course, other configurations can be used without departing from the spirit or scope of the present invention. The embodiment of FIG. 7 can allow for the more flexible use of materials to achieve the desired thermal and electrical performance. In some exemplary embodiments, the outer wrap 705 can fully encompass the inner wrap 105 and the insert 103—as shown by the dashed line in FIG. 7. Such embodiments can aid in saving costs as the inner wrap 103 can be of a first high thermally conductive material, and the outer wrap 705 can be of a second, less expensive high thermally conductive material. For example, the outer wrap 705 can have a thermal conductivity of at least 1,500 W/mK at 20° C., and the inner wrap 105 can have a thermal conductivity in the range of 500 to 1,000 at 20° C. Of course other ranges and ratios can be used to achieve the desired performance without departing from the spirit or scope of the present invention.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

1. A cutting electrode assembly, comprising:
an electrode body having a cooling cavity and a second cavity positioned at a distal end of the electrode body;
a thermally conductive shell inserted into said second cavity, where said thermally conductive shell has an outer wall surface and a shell cavity with an opening at a distal end of said thermally conductive shell; and
a thermionic emissive insert positioned in said shell cavity such that at least a distal end surface of said thermionic emissive insert is not enclosed,
wherein said thermally conductive shell has a thermal conductivity of at least 700 W/mK at 20° C., and
wherein said thermally conductive shell has a higher thermal conductivity than silver throughout a temperature range of 100 to 1,600° C.

2. The cutting electrode of claim 1, wherein said thermally conductive shell has a thermal conductivity of at least 1,000 W/mK at 20° C.

3. The cutting electrode of claim 1, wherein said thermally conductive shell has a thermal conductivity within the range of 1,000 to 2,500 W/mK at 20° C.

4. The cutting electrode of claim 1, wherein said thermally conductive shell contains a material having a thermal conductivity of at least 1,500 W/mK at 20° C.

5. The cutting electrode of claim 1, wherein said thermally conductive shell is electrically conductive.

6. The cutting electrode of claim 1, wherein said thermally conductive shell has a wall thickness in the range of 10 to 50 microns.

7. The cutting electrode of claim 1, wherein said thermally conductive shell has a wall thickness in the range of 0.04 to 0.2 inches.

8. The cutting electrode of claim 1, wherein said thermally conductive shell encloses said emissive insert except on said distal end of said electrode.

9. The cutting electrode of claim 1, wherein a wall of said second cavity is impregnated with a material having a thermal conductivity in the range of 500 to 1,000 W/mK at 20° C.

10. The cutting electrode of claim 1, wherein said thermally conductive shell has a length L which is in the range of 40 to 90% of the overall length LH of said insert.

11. The cutting electrode of claim 1, wherein said thermally conductive shell has a length L which is in the range of 55 to 80% of the overall length LH of said insert.

12. The cutting electrode of claim 1, wherein said thermally conductive shell is deposited onto an outer surface of said insert via vapor deposition.

13. The cutting electrode of claim 1, wherein said thermally conductive shell has a wall thickness which varies along a length of said thermally conductive shell.

14. A cutting electrode assembly, comprising:
an electrode body having a cooling cavity and a second cavity positioned at a distal end of the electrode body;
a thermally conductive shell inserted into said second cavity, where said thermally conductive shell has an outer wall surface and a shell cavity with an opening at a distal end of said thermally conductive shell; and
a thermionic emissive insert positioned in said shell cavity,
wherein said thermally conductive shell has a thermal conductivity of at least 700 W/mK at 20° C.,
wherein said thermally conductive shell has a higher thermal conductivity than silver throughout a temperature range of 100 to 1,600° C., and
wherein said thermally conductive shell has a diameter d at a distal end face of said distal end of said electrode body and said distal end face has a diameter D, and said diameter d is in a range of 35 to 95% of said distal end face diameter D.

15. The cutting electrode of claim 14, wherein said diameter d is in a range of 45 to 85% of said distal end face diameter D.

16. The cutting electrode of claim 1, wherein at least a portion of said thermally conductive shell is exposed to said cooling cavity.

17. A cutting electrode assembly, comprising:
an electrode body having a cooling cavity and a second cavity positioned at a distal end of the electrode body;
a thermally conductive shell inserted into said second cavity, where said thermally conductive shell has an outer wall surface and a shell cavity with an opening at a distal end of said thermally conductive shell; and
a thermionic emissive insert positioned in said shell cavity,
wherein said thermally conductive shell has a thermal conductivity of at least 700 W/mK at 20° C.,
wherein said thermally conductive shell has a higher thermal conductivity than silver throughout a temperature range of 100 to 1,600° C., and
wherein said thermally conductive shell has a first portion having a first wall thickness t and a second portion having a second wall thickness T, where said second wall thickness T is in a range of 50 to 400% larger than said first wall thickness t.

18. The cutting electrode of claim 17, wherein said second portion has a length L′ which is in a range of 35 to 75% of a length L of said shell.

19. A cutting electrode assembly, comprising:
an electrode body having a cooling cavity and a second cavity positioned at a distal end of the electrode body;
a thermally and electrically conductive shell inserted into said second cavity, where said conductive shell has an outer wall surface and a shell cavity with an opening at a distal end of said conductive shell; and
a thermionic emissive insert positioned in said shell cavity,
wherein said conductive shell has a thermal conductivity of at least 1,000 W/mK at 20° C.,
wherein said conductive shell has a higher thermal conductivity than silver throughout a temperature range of 100 to 1,600° C.,
wherein said conductive shell has a length L which is in a range of 40 to 90% of an overall length LH of said insert, and
wherein said thermally conductive shell has a diameter d at a distal end face of said distal end of said electrode body and said distal end face has a diameter D, and said diameter d is in a range of 35 to 95% of said distal end face diameter D.

20. A cutting electrode assembly, comprising:
an electrode body having a cooling cavity and a second cavity positioned at a distal end of the electrode body;
a thermally conductive shell inserted into said second cavity, where said thermally conductive shell has an outer wall surface and a shell cavity with an opening at a distal end of said thermally conductive shell; and
a thermionic emissive insert positioned in said shell cavity,
wherein said thermally conductive shell has a thermal conductivity in the range of 1,000 and 2,500 W/mK at 20° C.,
wherein said thermally conductive shell has a higher thermal conductivity than silver throughout a temperature range of 100 to 1,600° C.,
wherein said thermally conductive shell comprises a material having a thermal conductivity of at least 1,500 W/mK at 20° C., and
wherein said thermally conductive shell has a diameter d at a distal end face of said distal end of said electrode body and said distal end face has a diameter D, and said diameter d is in a range of 35 to 95% of said distal end face diameter D.
